(19) United States
(12) Patent Application Publication
(10) Pub. No.: US 2016/0314409 A1
(43) Pub. Date: Oct. 27, 2016

(54) METHOD AND SYSTEM FOR REAL TIME PRODUCTION OPTIMIZATION BASED ON EQUIPMENT LIFE

(71) Applicant: General Electric Company, Schenectady, NY (US)

(72) Inventors: Jose Luiz Bittencourt, Rio de Janeiro (BR); Carlos Gonzaga, Rio de Janeiro (BR)

(21) Appl. No.: 14/694,701

(22) Filed: Apr. 23, 2015

(51) Int. Cl. G06N 99/00; G05B 19/401

(52) U.S. Cl. CPC G06N 99/005; G05B 19/401; G05B 2219/32216

(57) ABSTRACT

A system and method include a controlled mechanical system coupled to self-optimization of equipment life system. The method includes providing a controlled mechanical system; collecting and aggregating data in a time series related to the controlled mechanical system for processing with a monitoring module; calculating an estimated current level of degradation of the controlled mechanical system from the collected and aggregated data with a learning and prognostic module; determining, with the learning and prognostic module, trade-offs between degradation and performance of the controlled mechanical system for the next optimization period; and calculating an optimum operating point for the controlled mechanical system based on the forecast and economic data with an optimization module. Numerous other aspects are provided.

### FIELD

One or more embodiments described below relate to the electrical, electronic and computer arts, and more particularly, to optimization of equipment and the like.

### BACKGROUND

The operation of mechanical systems may include several controlled variables, including temperature, pressure, speed, etc. It is often desirable to keep these variables under constraints of safety and performance. Nevertheless, many system control objectives are not directly associated with economic objectives.

Systems and methods are desired which optimize the use of a mechanical system with respect to economic objectives.

### SUMMARY

In accordance with an embodiment of the invention, a method is provided. The method includes providing a controlled mechanical system; collecting and aggregating data in a time series related to the controlled mechanical system for processing with a monitoring module; calculating an estimated current level of degradation of the controlled mechanical system from the collected and aggregated data with a learning and prognostic module; determining, with the learning and prognostic module, trade-offs between degradation and performance of the controlled mechanical system for the next optimization period; and calculating an optimum operating point for the controlled mechanical system based on the forecast and economic data with an optimization module.

In accordance with another embodiment of the invention, a system is provided. The system includes a controlled mechanical system; a monitoring module operative to collect and aggregate data in a time series related to the controlled mechanical system for processing; a learning and prognostic module operative to: calculate an estimated current level of degradation of the controlled mechanical system from the collected and aggregated data; determine trade-offs between degradation and performance of the controlled mechanical system for the next optimization period; and an optimization module operative to calculate an optimum operating point for the controlled mechanical system based on the forecast and economic data.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of elements for carrying out one or more of the method steps described herein; the elements can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Other features and aspects of the present invention will become more fully apparent from the following detailed description, the appended claims and the accompanying drawings.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 illustrates a block diagram of system architecture according to some embodiments;

FIG. 2 is a flow diagram of a process according to some embodiments of the present invention;

FIGS. 3A and 3B illustrate a series of charts according to some embodiments; and

FIG. 4 is block diagram of a system according to some embodiments.

### DETAILED DESCRIPTION

In industry, control systems may be designed to handle physical dimensions of mechanical systems. The operation of mechanical systems may include several controlled variables, including, for example, temperature, pressure, speed, fill level, flow rate, position etc. It is often desirable to keep these variables under constraints of safety and performance. Nevertheless, many system control objectives are not directly associated with economic objectives. Many controlled variables, when subjected to some optimization strategy, present conflicting objectives with respect to safety/performance and operational costs and, more generally, to economics. In addition, current plant-wide optimization systems may not present a seamless connection to local equipment controllers and cost reduction potentials may be neglected.

Accordingly, a framework and method for real time production system optimization based on equipment life is provided. A technical effect of embodiments of the invention is to provide a real time self-optimization framework to optimize a production system, and more particularly to balance, in real-time, the performance (and/or production output) of the production system and the life consumption of the production equipment. Another technical effect of embodiments of the invention is that an operator of a production system may, based on the optimization structure provided in embodiments herein, define objectives for the controller in order to reduce costs and maximize the profitability of the production system. Embodiments of the invention provide a multi-layer self-optimization structure including monitoring, learning and prognostics, and adaptation modules that may provide the economical optimum operating point for a production mechanical system based on the prognostic of equipment life and the correlated trade-offs (e.g., trade-offs between efficiency and performance (or productivity)).

As used herein, “self-optimization” of a technical system may be defined as the endogenous change of the system objectives according to changes in the surrounding conditions. This may lead to a compliant adaptation of parameters and/or control structure resulting in optimized system behavior. In this way, the self-optimization may differentiate itself from the typical adaptive feedback control by enabling inherent system “intelligence.” Therefore, a mechanical system may autonomously and flexibly react to changing operating conditions.

In the descriptions of the Figures, reference may be made to the following example. An example of a mechanical system or production equipment may be a simulated electrical submersible pump (ESP) (“pump”) in the oil and gas industry. This equipment may be operated remotely and may be subjected to harsh environmental conditions presenting a short Mean Time Between Failure (MTBF) (e.g., about 30 months). The operating point of the pump may be regulated by means of variable speed drivers. The operation of the pump may be controlled in order to optimize the production of a single well. To optimize the production of a single oil well, the trade-offs between flow rate (productivity), energy efficiency and lifespan may be determined The degradation of the pump may be the common factor that links productivity, energy efficiency and lifespan. As the remaining useful life (RUL) of the pump changes according to flow rate, for example, so changes the amount of produced barrels of oil per pump. Another consideration in determining optimization is that every time a pump breaks, it may be determined whether it is worth it to replace the pump and continue the well exploitation. Since the whole well exploitation may take years and make use of several pumps, one or more embodiments may calculate the net present value of the pump for the long term, such that estimations on the pump RUL and energy consumption may be provided for the current and future pumps.

In one or more embodiments, a goal of the optimization may be to recurrently define the flow rate setpoint that may bring the best cash flow during the whole well exploitation (highest net present value (NPV)). In one or more embodiments, to do this, an optimization module may use data that is periodically provided by a learning and prognostic module, and additional economic parameters that may be provided to self-optimization of equipment life system via a human machine interface (e.g., economic data module), or any other suitable manner.

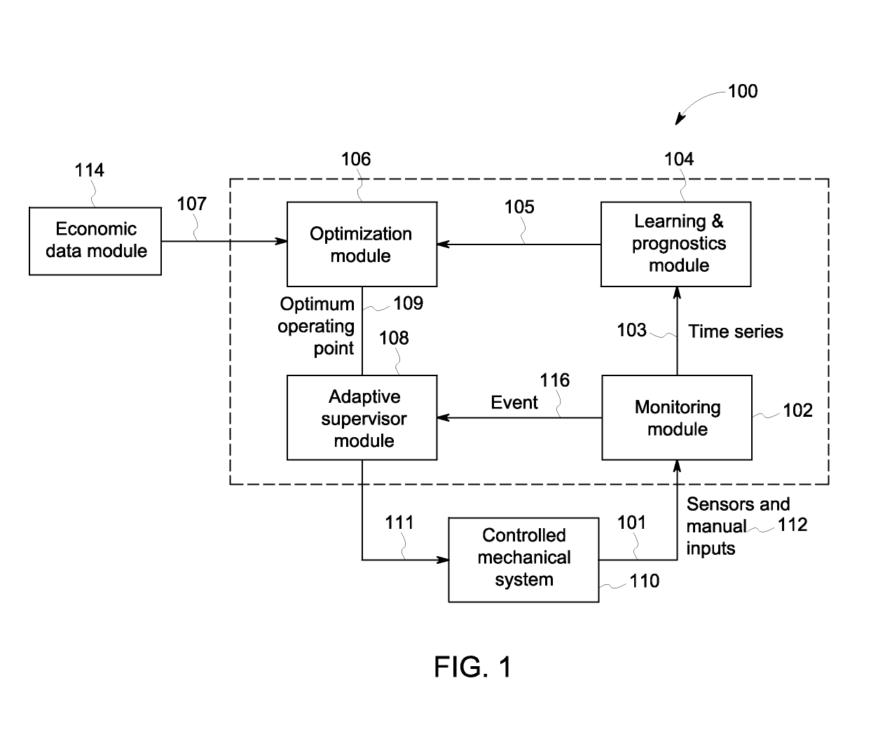

FIG. 1 is a block diagram of an example of a self-optimization of equipment life system 100. The system 100 may include a monitoring module 102, a learning and prognostics module 104, an optimization module 106, and an adaptive supervisor module 108. The monitoring module 102 and the adaptive supervisor module 108 may be connected to a controlled mechanical system 110.

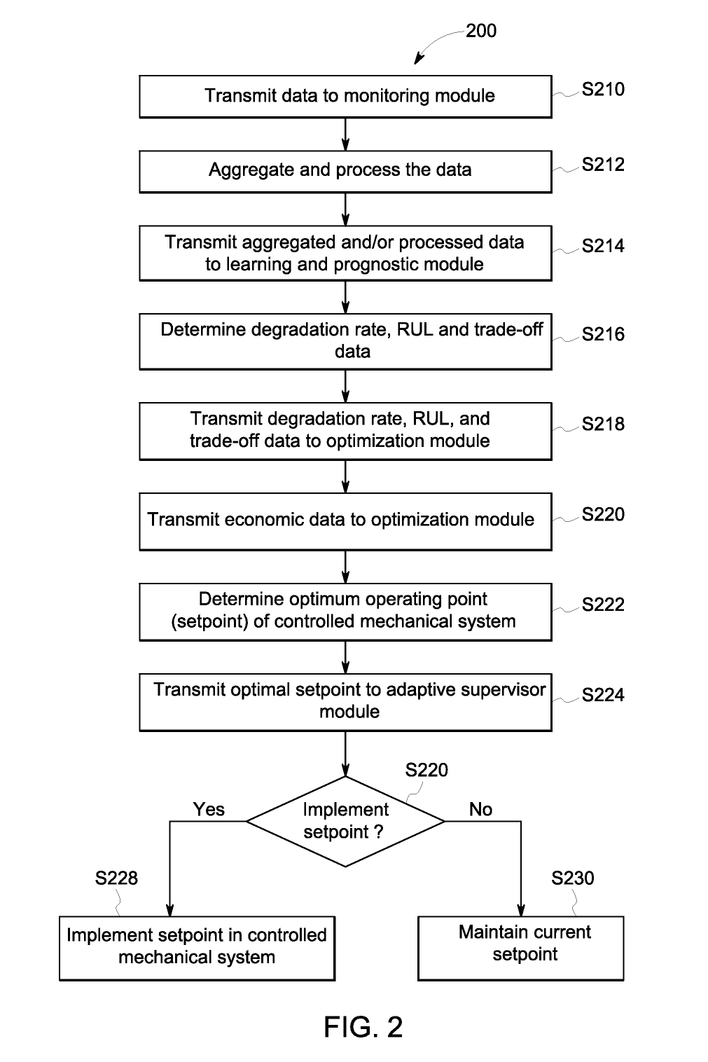

The controlled mechanical system 110 may be any mechanical system in a production system subjected to a feedback control loop that may affect the life consumption of the mechanical system depending on the way the mechanical system operates (e.g., pumps, compressors, turbines, control valves, etc.). Arrows 101, 103, 105, 107, 109 and 111 trace the optimization path. As part of the optimization process, arrows 101-111 represent communications between the components of the self-optimization of equipment life system 100, as will be further described below with respect to FIG. 2.

The monitoring module 102 may gather information (e.g., time series data) from one or more available sensors and other field data sources (e.g., manual inputs) 112. In one or more embodiments, the monitoring module 102 may apply signal processing methods to remove noise in the data signals (e.g., outliers, sensor drift, bias, etc.).

The learning and prognostics module 104 may use the time series data provided by the monitoring module 102 to estimate the current level of degradation and performance loss of the controlled mechanical system 110. In one or more embodiments, the learning and prognostics module 104 may apply at least one of Hidden Markov models, physics-based and data-driven modelling methods to estimate the current level of degradation and performance loss of the controlled mechanical system 100. In one or more embodiments, when a long-term projection that is greater than the equipment life is desired, the learning and prognostics module 104 may determine an estimated remaining useful life (RUL) of the production equipment, and this estimation may replace the degradation level estimations. In one or more embodiments, the learning and prognostics module 104 may, for a selected model, apply a flexible sliding window in the time domain for each variable in an optimization function to update the models in real-time. The flexible sliding window allows for the use of recent measurements for model accuracy monitoring. In one or more embodiments, if the model is no longer reliable (e.g., for an electrical submersible pump in a liquid well production system, the performance curve depends on nominal fluid density and pump speed. These two terms commonly vary throughout the well exploitation due to the increase in water fraction over total production volume and sand concentration), these same measurements may be used in the optimization function to adapt the model parameters. Then the learning and prognostics module 104 may use prognostics methods (e.g., direct methods in which the output model is the RUL estimate and indirect methods in which the output model is used to estimate the RUL) to forecast or determine trade-offs between life consumption (e.g., degradation rate and/or RUL) and performance for the next optimization period, both for short-term and long-term.

The optimization module 106 may use an economic objective function that correlates the profit provided by the controlled mechanical system 110 with the equipment useful life, energy efficiency and production output to define an optimum operating point for the controlled mechanical system 110 in real time. In one or more embodiments, the optimization module 106 may perform the optimization over different user-defined time scales (e.g., short-term and long-term). One of the benefits of a user-defined time scale is that the user has the option to interact with the system, and may want to consider optimization over different horizons depending on the stability of the economic scenario, for example. In one or more embodiments, the economic objective function value may be based on economic data provided to the optimization module 106 via an economic data module 114. In one or more embodiments, the economic data may include at least one of discounted payback, expected value added, return of investment, and net present value. Other suitable economic data may be included.

The adaptive supervisor module 108 may function under soft and hard real-time constraints. As used herein, “soft real-time constraints” operations of the system may be operations that may not be crucial for the safety of the overall system. For example, running an optimization problem of high dimension to determine the best operating point may be a soft real time constraint, as there is a small impact in safety if the system runs for a sub-optimum operating point for a period of time. As used herein, “hard real-time constraints” operations of the system may be operations that are crucial for the safety of the overall system. For example, hard real-time constraints operations may include operations of a control loop involving variables which must be kept at safety operating ranges or even one single value. With hard real-time constraints, the computation time for these control loops is critical for the overall safety system operation. In one or more embodiments, regarding soft real-time constraints, the adaptive supervisor module 108 may communicate with the optimization module 106, as further described below, to receive an indication of an optimal operating point for the controlled mechanical system 110, and then the adaptive supervisor module 108 may apply the optimal operating point to the controlled mechanical system. In one or more embodiments, safety procedures may be impacted by the application of the optimal operating point by the adaptive supervisor module 108 under real-time constraints. For example, for a sub-sea electrical pumping system controlled by embodiments of the invention, the desired economic operating point, which is the one that provides the most economic value, may, in some instances, be related with an unfeasible pump rotation speed, outside of the operational range. In this example, the conflict for the adaptive supervisor module 108, which aims at keeping the speed of the pump at this safety range, may be solved by prioritizing the speed defined by the adaptive supervisor module 108, regardless of the optimum operating point. In one or more embodiments, the adaptive supervisor module 108 may respond (e.g., alter the operating point for the controlled mechanical system 110) to unexpected operational events 116, that may be reported by the monitoring module 102, that violate the optimization assumptions. In keeping with the sub-sea electrical pumping system described above, the system, when operational, may be subject to abrupt changes and disturbance. It may be the duty of the adaptive supervisor module 108 to track and control the system in this situation. For example, a fragment of rock may be released in the reservoir yielding to an abrupt increase in the level of sand in the production fluid. This naturally characterizes an unplanned erosion level, or even a dangerous situation for the overall system. The adaptive supervisor module 108 may respond to minimize the risk of integrity of the system by implementing shut-down procedures, for example.

FIG. 2 illustrates a method 200 that might be performed by all or some of the elements of the system 100 described with respect to FIG. 1 according to some embodiments. The flow chart(s) described herein do not imply a fixed order to the steps, and embodiments of the present invention may be practiced in any order that is practicable. Note that any of the methods described herein may be performed using any suitable combination of hardware (e.g., circuit(s)), software or manual means. For example, a non-transitory computer-readable storage medium (e.g., a fixed disk, a floppy disk, a CD, a DVD, a Flash drive, or a magnetic tape) may store thereon instructions that when executed by a machine result in performance according to any of the embodiments described herein. In one or more embodiments, the components of the system 100 (e.g., the monitoring module 102, the learning and prognostics module 104, the optimization module 106 and the adaptive supervisor module 108) may be necessarily rooted in computer technology and may be conditioned to perform the process 200, such that the components and system 100 are special purpose elements configured to perform operations not performable by a general purpose computer or device. Examples of these processes will be described below with respect to the elements of the computing device, but embodiments are not limited thereto.

As S210 the controlled mechanical system 110 transmits 101 data to the monitoring module 102. In one or more embodiments, the data may be acquired from the controlled mechanical system 110 and the environment associated with the controlled mechanical system 110 via sensors and manual inputs 112, for example. Referring to the pump example, the sensors may, for example, assess how fast the pump is running or the concentration of particles in the pump, for example, which may have a value. In one or more embodiments, the manual inputs may refer to parameters that have been changed by an operator.

Then at S212, after collecting the data, the monitoring module 102 may aggregate and process the data. In one or more embodiments, the monitoring module 102 may process the data over different variables, and may apply signal processing methods to remove noise in the data signals (e.g., outliers, sensor drift, bias, etc.). In one or more embodiments, the monitoring module 102 may receive the data in a time series format whereby the data is associated with different points in time. In one or more embodiments, the time series is a form of storing the measurement variables captured by the sensors. In one or more embodiments, each measurement is assigned a tag with the time instance (e.g., each 1 second, 1 minute, etc.).

The monitoring module 102 transmits 103 the aggregated and/or processed data to the learning and prognostics module 104 in S214. In one or more embodiments, the learning and prognostics module 104 may determine via calculations the estimated current degradation and performance states estimation of the controlled mechanical system 110, as well as the prognosis of the RUL and energy consumption for the controlled mechanical system 110 and trade-off information based on the input received from the monitoring module 102 in S216. In one or more embodiments, the learning and prognostics module 104 may apply machine learning processes via statistical modeling to the time series data, for example, to estimate the current level of degradation and performance loss of the controlled mechanical system 110. In one or more embodiments, other data that measures life consumption may be used to determine RUL. For example, the number of cycles may be used to determine RUL, instead of time-series data. In one or more embodiments, some examples of statistical modeling applied by the learning and prognostics module 104 may include Hidden Markov models, physics-based models and data-driven models. In one or more embodiments, the learning and prognostics module 104 may apply at least one of Hidden Markov models, physics-based models and data-driven models. In one or more embodiments, the application of the models may describe how the controlled mechanical system 110 behaves under a given set of variables. In one or more embodiments, the learning and prognostic module 104 may include a test-case mode whereby a system user may change the variables to observe the effects on life consumption and production rate of the controlled mechanical system 110, without making real-time changes to the controlled mechanical system 110 itself. For example, the learning and prognostic module 104 may be connected to a simulator of the production system containing the controlled mechanical system. The simulation may allow the user to identify beforehand the impact of an eventual change of the operation conditions to the system. In one or more embodiments, when determining a degradation rate, as well as a prognosis for the RUL and power consumption, the models may make use of assumptions. For example, when determining a prognosis for the RUL of the pump, the models may take the flow rate as constant. In one or more embodiments, the assumptions may be defined in-locu depending on the specific application. In one or more embodiments, the user may define the assumptions following operation of an operational standard. For example, assigning a value to how often the desired flow rate/pump speed is changed throughout the production system operation. As another example, MTBF information may be used to define the degradation parameters used by the models, instead of specific failure data. In one or more embodiments, the learning and prognostic module 104 may also determine for each flow rate value in a range of flow rate values, a different RUL for the pump. In one or more embodiments, the range may be the operational range provided by the pump data sheet. In one or more embodiments, the operational flow may be defined according to the nominal speed of the pump and the specific weight of the fluid considered in the test, for example. In one or more embodiments, the number of cycles or time evolution per se of the controlled mechanical system 110 may be used, together with further available sensor data, to determine the estimated current degradation rate or the RUL.

In one or more embodiments, when the looking-ahead prediction time-line is greater than the equipment life, the RUL of the in-use controlled mechanical system 110 may be estimated by the learning and prognostics module 104 and used to replace the degradation level estimations, as inputs to the optimization module.

In one or more embodiments, the learning and prognostics module 104 may apply a flexible sliding window in the time domain for each variable in the optimization function to update the models online. As described above, the flexible sliding window allows for the use of recent measurements for model accuracy monitoring. In one or more embodiments, if the model is no longer reliable, these same measurements may be used in the optimization function to adapt the model parameters.

In one or more embodiments, the learning and prognostic module 104 may predict how the controlled mechanical system 110 may perform in the future based on user-defined variables. After the learning and prognostic module 104 determines the estimated degradation rate and RUL for the controlled mechanical system 110, the learning and prognostic module may, in some embodiments, apply prognostic methods to forecast trade-offs between life consumption and performance for the next user-defined optimization period. In one or more embodiments, the optimization period may be at least one of short-term and long-term. In one or more embodiments, the learning and prognostic module 104 may determine RUL and energy consumption estimations for both the current controlled mechanical system and future controlled mechanical systems. Referring again to the pump example, a whole well exploitation may span multiple years and make use of multiple pumps. As such, the RUL and energy consumption estimations determined by the learning and prognostic module 104 may be for both the current pump and the future replacement pumps.

In one or more embodiments, the learning and prognostic module 104 may perform a sensitivity analysis to identify which factors contribute the most to the estimation and prognostic deviations compared to a baseline. The sensitivity analysis may be implemented via commonly used methods such as one-at-a-time; local methods and emulation based methods (e.g. machine learning). Other suitable implementations may be used. In one or more embodiments, the sensitivity analysis may improve the optimization aspect of one or more embodiments.

Referring again to FIG. 2, at S218 the learning and prognostics module 104 transmits 105 the degradation rate, RUL and trade-off information to the optimization module 106. At S220, the economic data module 114 transmits 107 economic data to the optimization module 106. In one or more embodiments, the optimization module 106 may receive economic data from the economic data module 114 and the degradation rate, RUL and trade-off information from the learning and prognostics module 104 periodically at different times or substantially the same time and/or simultaneously. The economic data module 114 may be a “human-machine-interface,” and a system user may define the associated economic values of the optimization objectives (e.g., the oil barrel price, energy) and asset costs (e.g., the pump and intervention costs), for example. In one or more embodiments, the optimization module 106 may determine via calculations an optimum operating point for the controlled mechanical system 110 at S222. The optimization module 106 may define an “instantaneous” optimal set point profile (in the pump example, e.g., flow rate) to be defined for the next time period of use of the controlled mechanical system 110 based on the information received from the learning and prognostic module 104 and the economic data module 114. In one or more embodiments, the optimization module 106 may base the optimal set point, in part, on the trade-offs between equipment lifespan, energy efficiency and productivity. In one or more embodiments, the optimal set point may be the operating point that returns the highest economic value (e.g., in the pump example, the oil flow rate that can bring the best cash flow during the whole well exploitation). Conventionally, the optimal set point may be difficult to determine as the values received from sensors, for example, and economic values may be frequently changing.

In one or more embodiments, the optimization module 106 may solve the following expression:

$${max}_{Q} NPV ( Q )$$

where Q is the setpoint that will be passed to the adaptive supervisor module 108 to control the controlled mechanical system 110 and NPV is the Net Present Value, as presented in the equation below:

$$NPV ( Q ) = {\sum }_{k = 0}^{N} \frac{{C}_{k} ( Q )}{{( 1 + i )}^{k}}$$

where i represents a so-called discount-rate (e.g., the rate of return that could be earned on an investment in the financial markets with similar risk), k is the current period, N is the total number of cash flow periods being considered, and C_{K}(Q) is the function that describes the resulting cash flow of the period k, depending on Q. In one or more embodiments, the NPV may quantify the value of the money over time, as both incoming and outgoing cash flows may be affected, depending on the chosen setpoint.

Referring again to the pump example, as degradation rate and RUL change according to flow rate, so changes the amount of produced barrels per pumps. Therefore, depending on the selected flow rate a different number of pumps may be necessary to complete the well exploitation.

In one or more embodiments, the optimization module 106 may first calculate the maximum number of pumps needed to produce the maximum number of oil barrels. Then, the NPV(Q) may be calculated by the optimization module 106 for every possible number of pumps. The optimization module 106 may then determine and select the number of pumps that produces the highest NPV and may then define the optimum flow rate setpoint based on this information.

While NPV is used herein, other suitable optimization cost functions may be used. For example, any other cost function involving any desired trade-offs between the controlled variables may be used.

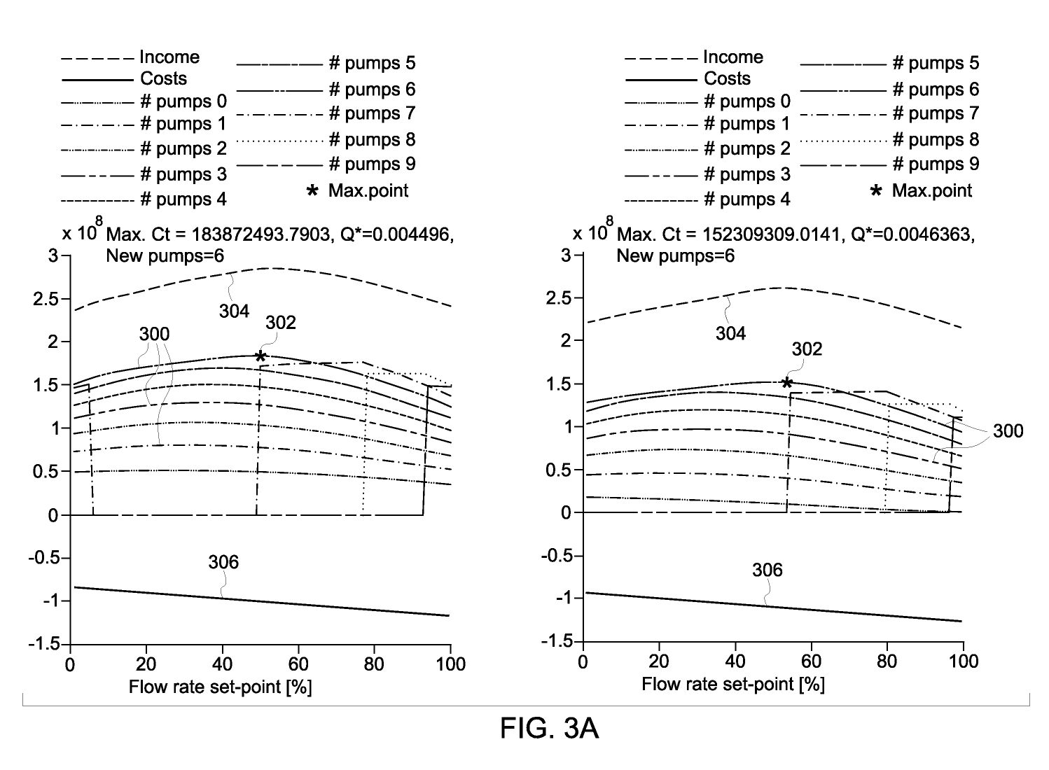

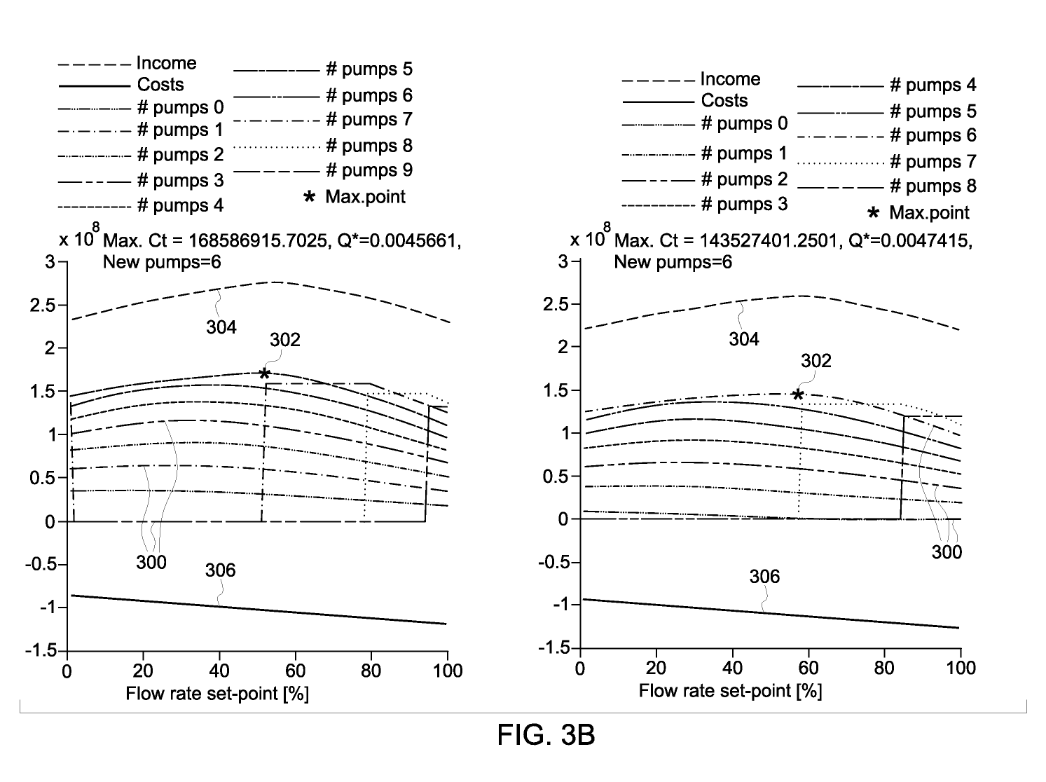

Referring again to the pump example, the optimization module 106 may calculate objective curves 300 for each possible total number of pumps on a weekly basis, as illustrated in FIGS. 3A and 3B. In FIGS. 3A and 3B, for example, four different operation weeks of the first pump within a period of 60 weeks is illustrated. Each objective curve 300 may be plotted in a different color, or with a different line style, for example, depending on the estimated number of necessary new pumps. In one or more embodiments, the selected flow rate (e.g., maximum value) may be represented by a star 302, or any other suitable indicator. The dashed curve 304 in FIGS. 3A and 3B corresponds to the total income expected for each operating point, while the solid black line 306 represents the estimated costs involved in the operation when selecting a specific flow rate at setpoint. In one or more embodiments, one or more objective curves may present steps after specific flow rates, as the respective total number of new pumps may only be achievable at higher flow rates.

In one or more embodiments, the optimization module 106 may apply additional optimization processes based on the input from the learning and prognostic module 104. For example, the optimization module 106 may apply additional objectives, (e.g., minimize the total number of pumps,) to account for input from the learning and prognostic module 104 to improve the optimization. As another example, one or more assumptions made in the learning and prognostic module 104 may result in the optimization module 106 generating an objective curve that may present a flat characteristic, whereby the peak value may change abruptly. This abrupt change may lead to an oscillation of the flow rate, for example, and consequently an error in the degradation rate and/or RUL estimation. In one or more embodiments, when the optimization module 106 detects a flat characteristic in the objective curve, the optimization module may apply an additional process to avoid this effect. An example of an additional process may be to apply a tolerance band to define a minimum necessary deviation of the peak value in order to change the set-point.

Referring again to FIG. 2, at S224, the optimization module 106 transmits 109 the optimal setpoint to the adaptive supervisor module 108. Then at S226, the adaptive supervisor module 108 determines whether the optimal setpoint should be implemented in the controlled mechanical system 110. If at S226 the adaptive supervisor module 108 determines the optimal setpoint should be implemented, the method proceeds to S228, and the adaptive supervisor 108 transmits a signal 111 such that the setpoint is implemented in the controlled mechanical system 110. If at S226 the adaptive supervisor module 108 determines the optimal setpoint should not be implemented, the method proceeds to S230, and the current setpoint is maintained and the optimal setpoint is not implemented. In one or more embodiments, the adaptive supervisor module 108 may receive information from the monitoring module 102 regarding an unplanned event 116 that may affect whether the optimal setpoint is implemented or not. For example, if the monitoring module 102 contains a multiphase flow meter, a change of water fraction in the production bulk fluid might be measured and transmitted to the adaptive supervisor 108 in real-time. Since this change may be significant in the income associated with the predicted total flow produced in short time of which the optimum setpoint was calculated, the adaptive supervisor 108 may decide to ignore or to accept to implement the optimum setpoint.

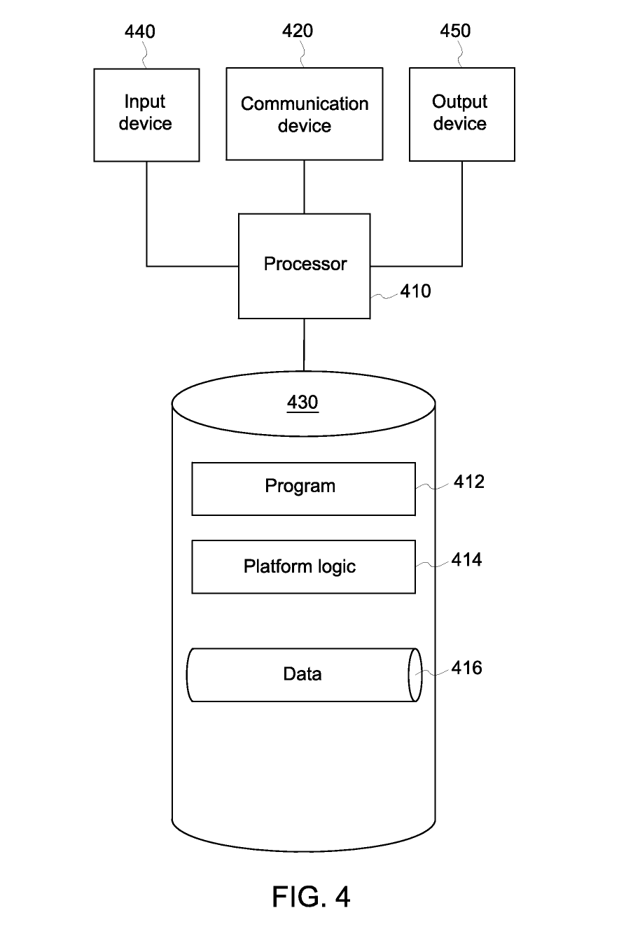

Note that the embodiments described herein may be implemented using any number of different hardware configurations. For example, FIG. 4 illustrates a Self-Optimization of Equipment Life Platform 400 that may be, for example, associated with the system 100 of FIG. 1. The Self-Optimization of Equipment Life Platform 400 comprises an equipment life optimization processor 410, such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more users or computers. The Self-Optimization of Equipment Life Platform 400 further includes an input device 440 (e.g., a computer mouse and/or keyboard to enter information about transactions) and an output device 450 (e.g., a computer monitor or printer to output a transaction information report and/or evaluation).

The processor 410 also communicates with a storage device/memory 430. The storage device 430 may comprise any appropriate information storage device, including combinations of magnetic storage devices (e.g., a hard disk drive), optical storage devices, mobile telephones, and/or semiconductor memory devices. The storage device 430 stores a program 412 and/or self-optimization platform logic 414 for controlling the processor 410. The processor 410 performs instructions of the programs 412, 414, and thereby operates in accordance with any of the embodiments described herein. For example, the processor 410 may receive sensor data and tradeoff information which may then be analyzed by the processor 410 to automatically determine an optimal setpoint. The storage device 430 may also store data 416 in a database, for example.

The process steps (e.g., programs 412, 414) stored in the storage device 430 may be read from one or more of a computer-readable medium, such as a floppy disk, a CD-ROM, a DVD-ROM, a Zip™ disk, a magnetic tape, or a signal encoding the process steps, and then stored in the storage device 430 in a compressed, uncompilled, and/or encrypted format. In alternative embodiments, hard-wired circuitry may be used in place of, or in combination with, processor-executable process steps for implementation of processes according to embodiments of the present invention. Thus, embodiments of the present invention are not limited to any specific combination of hardware and software. The programs 412, 414 may furthermore include other program elements, such as an operating system, a database management system, and/or device drivers used by the processor 410 to interface with peripheral devices.

As used herein, information may be “received” or “retrieved” by or “transmitted” to, for example: (i) the Self-Optimization of Equipment Life Platform 400 from another device; or (ii) a software application or module within the Self-Optimization of Equipment Life Platform 400 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a monitoring module, a learning and prognostics module, an optimization module, and an adaptive supervisor module. The method steps can then be carried out using the distinct software modules and/or sub-modules of the system, as described above, executing on one or more hardware processors 410 (FIG. 4). Further, a computer program product can include a computer-readable storage medium with code adapted to be implemented to carry out one or more method steps described herein, including the provision of the system with the distinct software modules

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A method comprising:
providing a controlled mechanical system;
collecting and aggregating data in a time series related to the controlled mechanical system for processing with a monitoring module;
calculating an estimated current level of degradation of the controlled mechanical system from the collected and aggregated data with a learning and prognostic module;
determining, with the learning and prognostic module, trade-offs between degradation and performance of the controlled mechanical system for the next optimization period; and
calculating an optimum operating point for the controlled mechanical system based on the forecast and economic data with an optimization module.

2. The method of claim 1, further comprising:
collecting and aggregating data from the environment associated with the controlled mechanical system.

3. The method of claim 1, wherein processing the data with the monitoring module further comprises:
filtering the data to account for at least one of outliers, sensor drift and bias.

4. The method of claim 1, further comprising:
calculating an estimated current performance loss of the controlled mechanical system from the collected and aggregated data with the learning and prognostic module.

5. The method of claim 1, wherein calculating an estimated current level of degradation further comprises:
applying at least one of physics-based models and data-driven models to the collected and aggregated data.

6. The method of claim 1, further comprising:
calculating a remaining useful life for the controlled mechanical system from the collected and aggregated data with the learning and prognostic module.

7. The method of claim 1, wherein the determined tradeoffs are for at least one of short-term and long-term projections.

8. The method of claim 1, wherein the optimum operating point is calculated in real time.

9. The method of claim 1, further comprising:
correlating, with an economic objective function, a profit provided by the mechanical system with at least one of a degradation rate of the controlled mechanical system, energy efficiency used by the controlled mechanical system and production output of the controlled mechanical system, via the optimization module, to calculate the optimum operating point.

10. The method of claim 9, wherein the economic objective function is based on one of discounted payback, expected value added, return of investment or net present value.

11. The method of claim 1, further comprising:
operating the controlled mechanical system at the calculated optimum operating point, via an adaptive supervisor module.

12. The method of claim 1, further comprising:
performing a sensitivity analysis, via the learning and prognostic module, to identify one or more factors that contribute the most to the estimated current level of degradation and prognostic deviations compared to a baseline.

13. A system comprising:
a controlled mechanical system;
a monitoring module operative to collect and aggregate data in a time series related to the controlled mechanical system for processing;
a learning and prognostic module operative to:
calculate an estimated current level of degradation of the controlled mechanical system from the collected and aggregated data;
determine trade-offs between degradation and performance of the controlled mechanical system for the next optimization period; and
an optimization module operative to calculate an optimum operating point for the controlled mechanical system based on the forecast and economic data.

14. The system of claim 13, wherein the monitoring module is further operative to:
collect and aggregate data from the environment associated with the controlled mechanical system.

15. The system of claim 13 wherein collected and aggregated data is filtered to account for at least one of outliers, sensor drift and bias.

16. The system of claim 13 wherein the learning and prognostic module is further operative to calculate an estimated current performance loss of the controlled mechanical system from the collected and aggregated data.

17. The system of claim 13, wherein the learning and prognostic module is operative to apply at least one of physics-based models and data-driven models to the collected and aggregated data to calculate the estimated current level of degradation.

18. The system of claim 13, wherein the learning and prognostic module is further operative to calculate a remaining useful life for the mechanical system from the collected and aggregated data.

19. The system of claim 13, wherein the learning and prognostic module is further operative to perform a sensitivity analysis to identify one or more factors that contribute the most to the estimated current level of degradation and prognostic deviations compared to a baseline.

20. The system of claim 13, wherein the determined tradeoffs are for at least one of short-term and long term projections.

21. The system of claim 13, wherein the optimum operating point is calculated in real time.

22. The system of claim 13, wherein the optimization module is further operative to correlate, via an economic objective function, a profit provided by the controlled mechanical system with at least one of a degradation rate of the mechanical system, energy efficiency used by the controlled mechanical system and production output of the controlled mechanical system to calculate the optimum operating point.

23. The system of claim 22, wherein the economic objective function is based on one of discounted payback, expected value added, return of investment or net present value.

24. The system of claim 13, further comprising:
an adaptive supervisor module operative to operate the controlled mechanical system at the calculated optimum operating point.
